(19) United States
(12) Patent Application Publication
(10) Pub. No.: US 2024/0127818 A1
(43) Pub. Date: Apr. 18, 2024

(54) Structuring and Displaying Conversational Voice Transcripts in a Message-style Format

(71) Applicant: DISCOURSE.AI, INC., Dallas, TX (US)

(72) Inventors: David John Attwater, Dallas, TX (US); Jonathan E. Eisenzopf, Dallas, TX (US)

(73) Assignee: DISCOURSE.AI, INC., Dallas, TX (US)

(21) Appl. No.: 17/964,196

(22) Filed: Oct. 12, 2022

(51) Int. Cl. G10L 15/26; G10L 15/22

(52) U.S. Cl. CPC G10L 15/26; G10L 15/22; G10L 2015/228

(57) ABSTRACT

A computer-generated visualization is created automatically in a format resembling a vertically-scrollable text-messaging user interface by segmenting the voice transcript into phrases, resolving how to indicate visually or to suppress periods of overlapping discussion (overtalk, interruption, etc.) by applying one or more rules, transformations, or both, and outputting the visualization onto a computer display device, into a printable or viewable report, or both.

### INCORPORATION BY REFERENCE

The following extrinsic publicly-available documents, white papers and research reports are incorporated in part, if noted specifically, or in their entireties absent partial notation, for their teachings regarding methods for visualization of conversations, turn determination in conversations, representations of spoken conversations, turn-taking modeling and theory:
(a) Aldeneh, Zakaria, Dimitrios Dimitriadis, and Emily Mower Provost. “Improving end-of-turn detection in spoken dialogues by detecting speaker intentions as a secondary task.” 2018 IEEE International Conference on Acoustics, Speech and Signal Processing (ICASSP). IEEE, 2018.
(b) Bosch, Louis & Oostdijk, Nelleke & De Ruiter, January (2004). “Durational Aspects of Turn-Taking in Spontaneous Face-to-Face and Telephone Dialogues.” 3206. 563-570. 10.1007/978-3-540-30120-2_71.
(c) Bosch, Louis & Oostdijk, Nelleke & De Ruiter, January (2004). “Turn-taking in social talk dialogues: temporal, formal and functional aspects.” Physical Review Letters. Also SPECOM 2004: 9th Conference, Speech and Computer. St. Petersburg, Russia, Sep. 20-22, 2004.
(d) Calhoun, Sasha & Carletta, Jean & Brenier, Jason & Mayo, Neil & Jurafsky, Dan & Steedman, Mark & Beaver, David. (2010). “The NXT-format Switchboard Corpus: A rich resource for investigating the syntax, semantics, pragmatics and prosody of dialogue.” Language Resources and Evaluation. 44. 387-419. 10.1007/s10579-010-9120-1.
(e) Chowdhury, Shammur. (2017). “Computational Modeling Of Turn-Taking Dynamics In Spoken Conversations.” 10.13140/RG.2.2.35753.70240.
(f) Cowell, Andrew, Jerome Haack, and Adrienne Andrew. “Retrospective Analysis of Communication Events-Understanding the Dynamics of Collaborative Multi-Party Discourse.” Proceedings of the Analyzing Conversations in Text and Speech. 2006.
(g) Lerner, Gene H.; “Turn-Sharing: The Choral Co-Productions of Talk in Interaction”; available at online from ResearchGate (dot net), published January 2002.
(h) von der Malsberg; Tito, et al; “TELIDA:A Package for Manipulations and Visualization of Timed Linguistic Data”; Proceedings of SIGDIAL 2009: the 10th Annual Meeting of the Special Interest Group in Discourse and Dialogue, pages 302-305, Queen Mary University of London, September 2009, Association for Computational Linguistics.
(i) Hara, Kohei, et al. “Turn-Taking Prediction Based on Detection of Transition Relevance Place.” INTERSPEECH. 2019.
(j) Jefferson, Gail (1984). “Notes on some orderlinesses of overlap onset” (PDF). Discourse Analysis and Natural Rhetoric: 11-38. Von Der Malsburg, Titus, Timo Baumann, and David Schlangen. “TELIDA: a package for manipulation and visualization of timed linguistic data.” Proceedings of the SIGDIAL 2009 Conference. 2009.
(k) Masumura, Ryo, et al. “Neural dialogue context online end-of-turn detection.” Proceedings of the 19th Annual SIGdial Meeting on Discourse and Dialogue. 2018.
(l) McInnes, F., and Attwater, D. J. (2004). “Turn-taking and grounding in spoken telephone number transfers.” Speech Communication, 43(3), 205/223.
(m) Sacks, Harvey & Schegloff, Emanuel & Jefferson, Gail. (1974). “A Simple Systematic for the Organization of Turn Taking in Conversation.” Language. 50. 696-735. 10.2307/412243.
(n) Schegloff, Emanuel, “Overlapping talk and the organization of turn-taking for conversation”. Language in Society 29, 1-63.
(o) Schegloff, Emanuel. (1987). “Recycled turn beginnings; A precise repair mechanism in conversation's turn-taking organization.”, Talk and Social OrganizationPublisher: Multilingual Matters, Ltd
(p) Schegloff, Emanuel. (1996). “Turn organization: One intersection of grammar and interaction.” 10.1017/CB09780511620874.002.
(q) Venolia, Gina & Neustaedter, Carman. (2003). “Understanding Sequence and Reply Relationships within Email Conversations: A Mixed-Model Visualization.” Conference on Human Factors in Computing Systems—Proceedings. 361-368. 10.1145/642611.642674.
(r) Weilhammer, Karl & Rabold, Susen. (2003). “Durational Aspects in Turn Taking.” Proceedings of the International Conference of Phonetic Sciences.
(s) Yang, Li-chiung. “Visualizing spoken discourse: Prosodic form and discourse functions of interruptions.” Proceedings of the Second SIGdial Workshop on Discourse and Dialogue. 2001.

For the purposes of this disclosure, these references will be referred to by their year of publication and the last name of the first listed author (or sole author).

### FIELD OF THE INVENTION

The present invention relates to computer-based analysis and visual presentation of information regarding transcribed voice conversations.

### BACKGROUND OF INVENTION

Voice transcripts of spoken conversation are becoming more common due to the easy access to audio capture devices and the availability of accurate and efficient speech-to-text processes. Such transcripts can be captured anywhere that conversations occur between two or more people. Examples include, but are not limited to, conversations in contact centers, transcripts of meetings, archives of social conversation, and closed-captioning of television content and video interviews.

These transcripts can be utilized in a number of ways. They can be reviewed directly by people or further analyzed and indexed by automated processes, for example to label regions of meaning or emotional affect.

In some cases, the digitized audio will be retained alongside the transcript in computer memory or digital computer files. In other cases, the transcript may be retained and the audio discarded or archived separately.

### SUMMARY OF THE DISCLOSED

### Embodiments of the Invention

A visualization is created automatically by a computer in a format resembling a vertically-scrollable text-messaging user interface by segmenting the voice transcript into phrases, resolving how to indicate visually or to suppress periods of overlapping discussion (overtalk, interruption, etc.) by applying one or more rules, transformations, or both, and outputting the visualization onto a computer display device, into a printable or viewable report, or both.

### BRIEF DESCRIPTION OF THE DRAWINGS

The figures presented herein, when considered in light of this description, form a complete disclosure of one or more embodiments of the invention, wherein like reference numbers in the figures represent similar or same elements or steps.

FIG. 1 depicts a generalized logical process performed by a system according to the present invention.

FIG. 2 depicts a computer display of waveforms plots for two hypothetical speakers having a conversation with each other.

FIG. 3 illustrates how a voice conversation display may be overlaid with the associated transcribed text for each contribution into the conversation, approximately oriented with the same timing as the audio.

FIG. 4 shows a typical user interface for visualizing a message-based conversation with interactive scrolling action to show portions of the conversation before and after the portion that is currently visible on a computer display.

FIG. 5 shows a horizontal ‘swim-lane’ style visualization of the information presented in TABLE 1.

FIG. 6 illustrates a swim-lane style visualization in which alternation between speakers is indicated visually as an extra signal for potential turn boundaries.

FIG. 7 shows the same dialog as FIG. 6, albeit visualized a “chat” or text-messaging style vertical manner.

FIG. 8 illustrates the same example conversation as FIG. 7 with certain dialog features de-emphasized.

FIG. 9 depicts the same example conversation as FIG. 7 with certain dialog features completely elided.

FIG. 10 shows a horizontal swimlane visualization of the word sequences of TABLE 2 with start and end times aligned.

FIG. 11 sets forth results of turn-gathering according to the present invention when applied to example data of TABLE 2 through which words are joined into phrases.

FIG. 12 illustrates measurements which are performed by processes according to the present invention, such as but not limited to duration of each utterance, gap times between the end of the first and start of the second utterance of each speaker, delta times, and numbers of words in utterances.

FIG. 13 sets forth an example set of process results, according to the present invention, resulting from a joining transformation.

FIG. 14 depicts a fragment of dialog in a wider context in which a vertical alternating swim lane visualization of a sample dialog that has been transformed by ordering utterances and joining co-located utterances from the same speaker.

### DESCRIPTION OF EXEMPLARY EMBODIMENTS ACCORDING TO THE INVENTION

The present inventors have recognized several shortcomings in processes of the state-of-the-art technologies for producing human-readable visualizations on computer screens and other computer output types (printers, etc.) of conversations. The following paragraphs describe some of these existing systems, the shortcomings which the present inventors have recognized, and the unmet needs in the relevant arts.

Current Methods of Visualizing Voice Transcripts. For the purposes of this disclosure, a “voice transcript” or “transcript” will refer to a written description representing an audio recording, typically stored in an electronic text-based format. The transcript may have been created by a computer transcriber, by a human, or by both. Similarly, conversational voice transcripts will refer to transcripts of audio recordings of two or more speakers having a conversation between the speakers.

Voice transcripts of spoken conversation are becoming more common due to the easy access to audio capture devices and the availability of accurate and efficient speech-to-text processes. Such transcripts can be captured anywhere that conversations occur between two or more people. Examples include, but are not limited to, conversations in contact centers, transcripts of meetings, archives of social conversation, and closed-captioning of television content and video interviews.

These transcripts can be utilized in a number of ways. They can be reviewed directly by people or further analyzed and indexed by automated processes, for example to label regions of meaning or emotional affect.

In some cases, the digitized audio will be retained alongside the transcript. In other cases, the transcript may be retained and the audio discarded or archived separately.

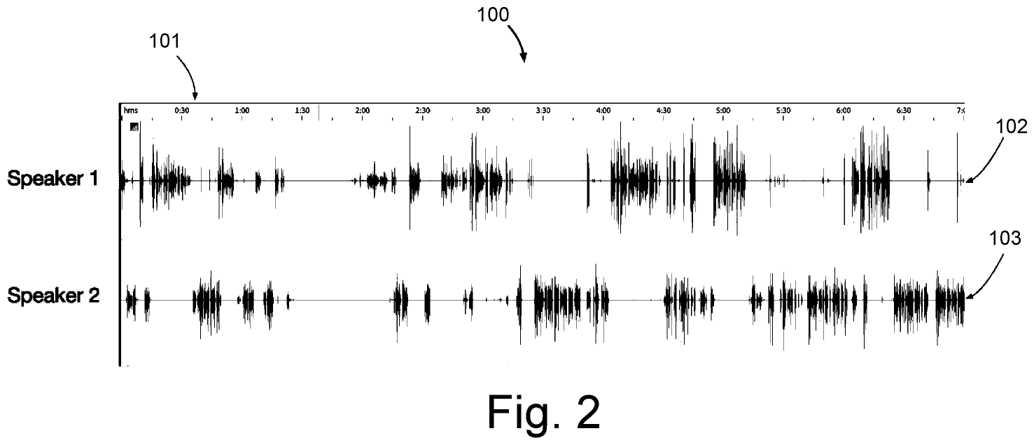

When displaying voice conversations, many existing computer applications display a horizontal orientation of an audio waveform with one row per speaker. FIG. 2, depicts a computer display 100 of waveforms plots for a hypothetical Speaker 1 102 and for a hypothetical Speaker 2 103 having a conversation with each other. These waveforms 102, 103 are displayed horizontally progressing in time from left to right in a conventional manner, synchronized to the speech by both parties. Such a conventional time representation of audio waveforms is typically marked in the y-axis in units of amplitude, and in the x-axis in units of time.

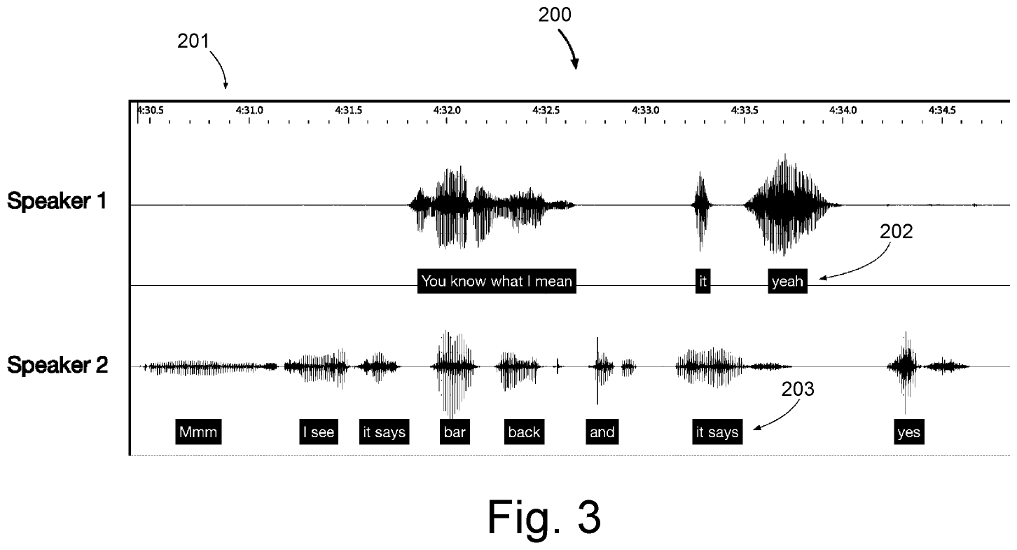

As illustrated 200 in FIG. 3, when displaying a voice conversation which is overlaid with the associated transcribed text for each contribution into the conversation, many computer applications display the text 202, 203 approximately oriented with the same timing as the audio.

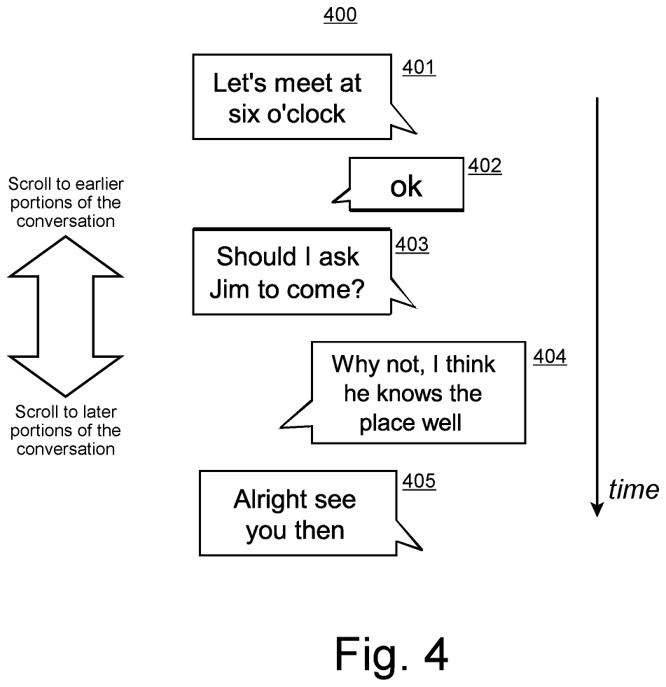

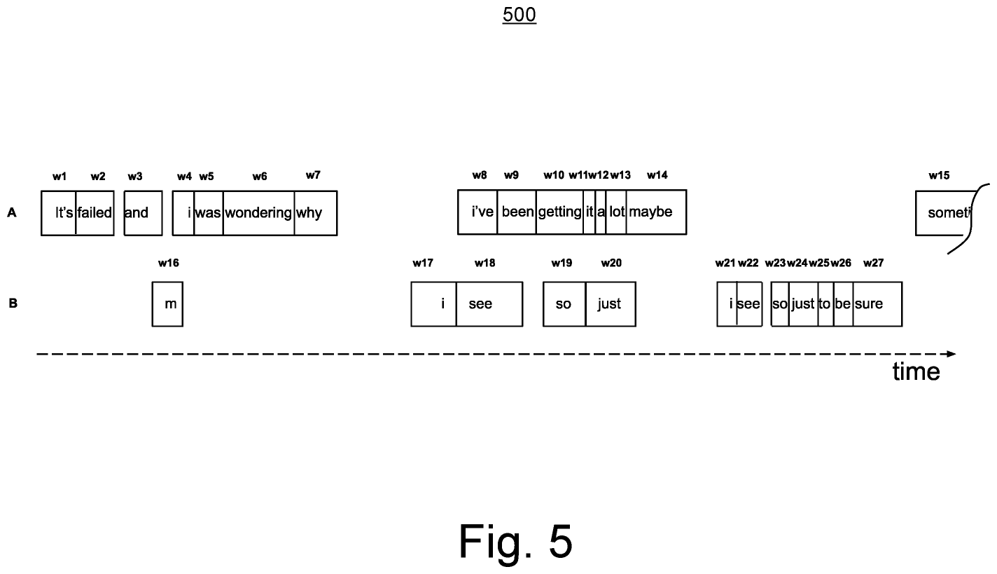

Current methods for visualizing text conversations. With the high consumer adoption of instant messaging applications such as Facebook Messenger™ provided by Meta Platforms, Inc., of Menlo Park, California, USA, and text messaging applications such as short message service (SMS), users have become familiar with the visual representation on computer, tablet and smartphone displays which provide interactive vertically-scrolling text conversations that are input on mobile devices or computers with keyboards, as shown 400 in FIG. 4. Often, as a further visual aid to the user, each contribution of text into the conversation is enclosed in a graphic shape, such as a call-out box or thought bubble type of shape, which may also be color coded or shaded to represent which “speaker” (i.e., conversation party) made each contribution. In this monochrome depiction 400, it appears that there are only two parties in the conversation as indicated by the direction of the pointing element of the call out boxes 401-405, and that the conversation progresses in time from top to bottom, with the conversation contribution 401 being the earliest in the transcript (or the earliest in the selected portion of the conversation), and contribution 405 being the latest in the transcript (or the latest in the selected portion of the conversation). Other systems or application programs may represent the contributions in temporal order from bottom to top, and may use other shapes or colors to provide indication of the contributor (speaker) for each contribution.

The present inventors have recognized an unmet need in the art regarding these computer-based depictions of voice-based conversational transcripts in that they do not necessarily lend themselves towards the familiar vertically-scrolling messaging format due to several differences in how voice conversations unfold compared to how text messaging unfolds over time. One such difference is that, in voice conversations, it is normal for participants to speak at the same time (simultaneously), which we will refer to as overtalk. However, overtalk does not occur in text-based messaging conversations because contributions are prepared (typed) by each speaker and then instantly contributed in their entireties at a particular time in the conversation. Therefore, the digital record of a text message conversation is already encapsulated into time-stamped and chronologically-separated contributions, whereas voice-based conversations do not exhibit this inherent formatting.

Turn Taking And Overlapping Speech. In text messaging conversations, speakers indicate completion of their ‘turn’ by hitting ‘enter’ or pressing a ‘send’ button. Overtalk is avoided by the mechanism provided to enter a contribution into the conversation. In spoken conversations, however, speakers do not always wait for the other person to end what they are saying before speaking themselves. They talk over one another frequently, as discussed by Schegloff (2000). Turn-taking phenomena are varied and well studied. Using the taxonomy identified in Chowdhury (2017), key turn-taking phenomena highlighted in the literature includes:
(a) Smooth speaker-switch—A smooth speaker-switch between the current and next speaker with no presence of simultaneous speech.
(b) Non-competitive overlap—Simultaneous speech occurs but does not disrupt the flow of the conversation and the utterance of the first speaker is finished even after the overlap.
   (1) Back-channel—one speaker interjects a short affirmation to indicate that they are listening (e.g. “uh huh, right, go on”). Also called continuers, as discussed by Schegloff (2000).
   (2) Recognitional overlap—one speaker speaks the same words or phrase along at the same time or completes their utterance for them to indicate agreement or understanding. (sometimes termed collaborative utterance construction), as discussed by Jefferson (1984).
   (3) Choral Productions. Speakers join together in a toast or greeting, as discussed by French (1983).
(c) Competitive overlap—One speaker speaks over the other in a competitive manner. Simultaneous speech occurs and the utterance of the interrupted speaker remains incomplete.
   (1) Yield Back-off—The interrupted speaker yields to the interrupting speaker.
   (2) Yield Back-off and Re-start—The interrupted speaker backs-off and then re-presents the utterance when a suitable turn-taking opportunity occurs.
   (3) Yield Back-off and Continue—The interrupted speaker backs-off and then continues the utterance when a suitable turn-taking opportunity occurs.
(d) Butting-in competition—an unsuccessful attempt of competitive overlaps, the overlapper does not gain control of the floor.
   (1) Over-talk—the interrupting speaker completes their utterance but the interrupted speaker continues over them and holds the floor.
   (2) Interrupt Back-off—the interrupting speaker yields to the other without completing his or her phrase.
(3) Interrupt Back-off and Re-start—The interrupting speaker backs-off and then re-presents the utterance when a suitable turn-taking opportunity occurs.
   (4) Interrupt Back-off and Continue—The interrupting speaker backs-off and then continues the utterance when a suitable turn-taking opportunity occurs.
(e) Silent competition—A competitive turn but without overlapping speech.

The signals that characterize these phenomena are a complex mix of pitch, stress, pausing, and syntax. More than one such phenomena can be occurring simultaneously, and different speakers have different habitual turn-taking strategies and habits.

Most theories of turn-taking recognize the importance of the transition relevance place (TRP). These are points in time within the conversation of possible completion (or potential end) of an utterance. Smooth speaker transitions and non-competitive overlaps generally occur at or around TRPs.

Speech-to-text services. The previous section highlighted why it is a non-trivial problem to identify the start and end of speaker turns in spoken conversation. For this reason many speech-to-text processes do not even attempt this task, leaving it up to the client application to make such decisions. Instead, the speech-to-text processes recognize each speaker independently and output a sequence of words for each speaker with the start and end timings for each word, such as the example conversation shown in TABLE 1 between an agent and a client.

TABLE 1
Example Speech-to-Text Process Output

| start_ms | end_ms | speaker | text | Word Ix | Phrase Ix |
|---|---|---|---|---|---|
| 54370 | 54870 | client | it's | w1 | P1 |
| 54890 | 55390 | client | failed | w2 | |
| 56050 | 56090 | client | and | w3 | |
| 56060 | 56250 | agent | m | w16 | P2 |
| 56130 | 56250 | client | i | w4 | P3 |
| 56250 | 56450 | client | was | w5 | |
| 56450 | 56950 | client | wondering | w6 | |
| 56970 | 57470 | client | why | w7 | |
| 58490 | 58650 | agent | i | w17 | P4 |
| 58650 | 59150 | agent | see | w18 | |
| 58742 | 58901 | client | I've | w8 | P5 |
| 58901 | 59021 | client | been | w9 | |
| 59021 | 59220 | client | getting | w10 | |
| 59220 | 59340 | client | it | w11 | |
| 59248 | 59447 | agent | so | w19 | P6 |
| 59340 | 59499 | client | a | w12 | P7 |
| 59447 | 59947 | agent | just | w20 | P8 |
| 59499 | 59738 | client | lot | w13 | P9 |
| 59738 | 60238 | client | maybe | w14 | |
| 61322 | 61561 | agent | i | w21 | P10 |
| 61561 | 61920 | agent | see | w22 | |
| 62039 | 62159 | agent | so | w23 | |
| 62159 | 62319 | agent | just | w24 | |
| 62319 | 62438 | agent | to | w25 | |
| 62438 | 62558 | agent | be | w26 | |
| 62558 | 62837 | agent | sure | w27 | |
| 63435 | 63674 | client | sometimes | w15 | P11 |
| 63674 | 64113 | client | i | w28 | |
| 64113 | 64432 | client | can | w29 | |
| 64432 | 64791 | client | see | w30 | |
| 64791 | 65030 | client | it | w31 | |
| 65030 | 65344 | client | and | w32 | |
| 65684 | 66184 | client | sometimes | w33 | |
| 66967 | 67467 | client | i | w34 | |
| 67525 | 67724 | client | cant | w35 | |

In the typical example of the output of a speech-to-text service shown in TABLE 1, each word is individually recognized and has the following four attributes: start time, end time, speaker, and text. The actual format may be in any structured text format such as comma separated values (CSV), JSON or YAML. It is also known to those skilled in the art that speech-to-text services may return alternate interpretations of the same conversation. For example, an acyclic graph of possible words and other tokens such as those representing silence or other paralinguistic phenomena, may be returned for each speaker with associated transition probabilities and start and end timings. It is known by those skilled in the art how to map such a representation into the tabular form presented in TABLE 1. For example, Dijkstra's process may be used to find the lowest cost path through the graph.

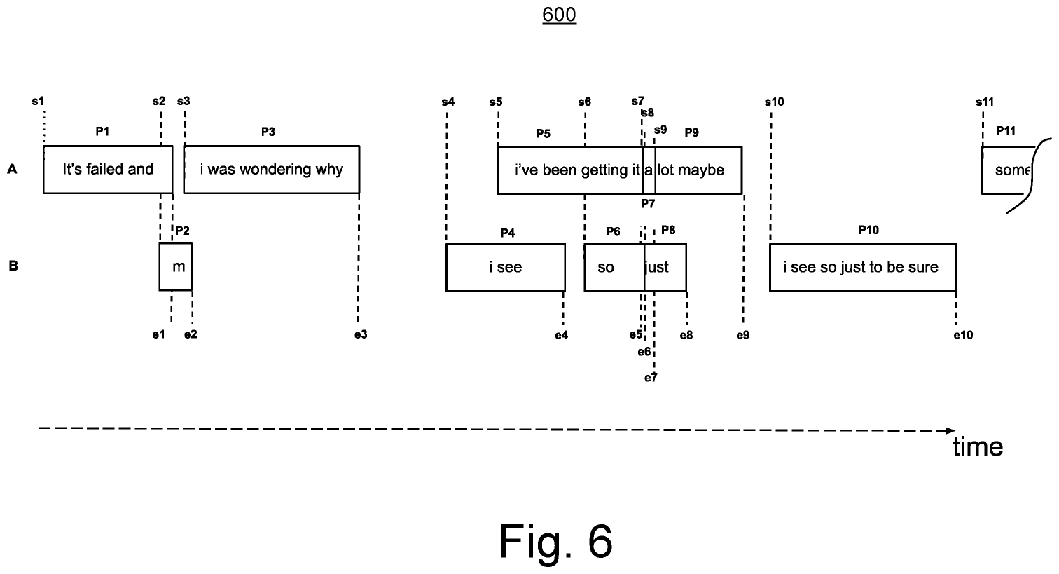

FIG. 5 shows 500 a horizontal ‘swim-lane’ style visualization of the same information presented in TABLE 1. Time is represented by the horizontal axis and two ‘lanes’ A and B are presented, one for each speaker. The size and location of each box represent the start and end times for each word as detected by the speech-to-text engine. In TABLE 1 and FIG. 5, we also add an index to each word (w1, w2, etc.) to assist with the description of the diagram. Some turn-taking phenomena that can be seen in this example are listed below:
(a) Speaker B gives a back-channel at word w16. This has been recognized as ‘m’ by the speech-to-text engine but is likely to be a sound like “hmm’.
(b) Speaker A ends their turn at w7
(c) Speaker B starts a fresh turn at w17.
(d) Speaker A also starts a fresh turn at w8. This is a competitive overlap but may have occurred simply as a clash rather than an intentional interruption.
(e) Speaker B yields the floor and backs-off at w20.
(f) Speaker A ends their next turn at w14.
(g) Speaker B then re-presents the utterance that was started at w17 and backed-off at w20 as the utterance w21 through w27.

Aligning visualizations with perceptions of spoken dialog. The nature of turn overlaps and interruptions means that the meaning of a user utterance may be spread across multiple phrases in time.

In spoken conversation, the brain has evolved to mentally ‘edit’ spoken dialog and restructure it for maximal comprehension. We mentally join words or phrases that carry related meaning and edit-out interruptions that impart little or no extra meaning. Examples of phenomena that break-up the conversation include back-channels, back-offs, self-repairs and silent or filled pauses used for planning. In the presence of such phenomena, conversants or listeners continue to perceive the conversation evolving in an orderly fashion as long as there is not a break-down in the actual communication.

When these phenomena are reproduced in visualizations of spoken dialog, users do not have the same mental apparatus to quickly edit and interpret what they are seeing. This task becomes even harder when the speech-to-text engine also introduces recognition errors—forcing the user to also interpret missing or mentally replace substituted words. Users either need to either develop new skills or the visualization needs to present and restructure information in a way that helps to reduce the cognitive demand of the task, whereas this is not a mental process common among users of visual representations of transcripts of spoken conversations. The interpretation and understanding task becomes even more difficult when there are 3 or more (N) speakers involved in the conversation simultaneously.

Current approaches to turn taking segmentation in voice transcripts. Current approaches to the detection of turn boundaries in spoken conversations typically seek pauses between words or phrases from a single speaker. If they are above a certain time threshold then a turn boundary is considered to be present.

An example of the current state of the art would be to gather together words that have contiguous timing at word boundaries. For example, in TABLE 1 word “I” (w4) can be seen to end at exactly the same time that the word ‘was’ (w5) begins. There is, however, no guarantee that the speech-to-text process will (or even should) deliver contiguous word timings. Notice, for example, there is a 120 ms gap between the end of ‘failed’ (w2) and ‘and’ (w3). There is also a 119 ms gap between ‘see’ (w22) and ‘so’ (w23). Many of the words have much smaller gaps between them, for example, the 20 ms gap between ‘it's’ (w1) and ‘failed’ (w2). To make this approach workable it is a known practice to join together words that have less than a fixed gap between their start and end times (for example, less than 150 ms).

This approach is dependent on the availability of the start and end times for each word. These are not always present. The approach also does not take into account the information that is available from the other speaker. This approach also makes the assumption that utterances from the same speaker that are separated by a significant pause are not part of the same turn.

Summary of the Shortcomings of the Existing Technologies. As such, the foregoing paragraphs describe some, but not all, of the limitations to the existing technologies, to which the present invention's objectives are directed to solve, improve and overcome. The remaining paragraphs disclose one or more embodiments of the present invention.

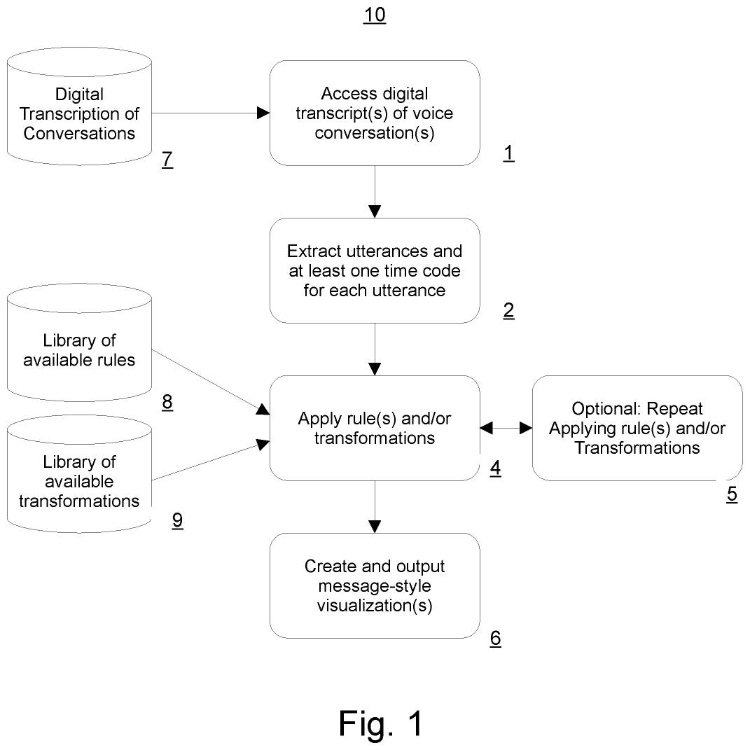

A New Process for Rendering Conversation Visualizations. Referring now to FIG. 1, a generalized process 10 according to the present invention is shown, which is suitable for performance by one or more computer processors. A visual depiction of a voice conversation for display on a computer output device or output into a digital report starts, generally, but the computer processor accessing a digital text-based transcript 7 of an unstructured multi-party audio conversation, then extracting 2 a plurality of utterances and at least one digital time code per utterance. Next, the computer processor applies 4 one or more rules 6 and one or more transformations 9 to resolve one or more time-sequence discrepancies between dialog features. Then, the computer processor prepares 6 a graphic a visualization a conversational format which resembles a message-based conversation containing the plurality of utterances organized in a time-sequential format wherein the visualization includes the resolutions to the time-sequence discrepancies, and this graphic visualization is output to one or more computer output devices, such as a display, digital file, communication port, printer, or a combination thereof. The rule and transformation applying 4 may be repeated 5 one or more times to yield further simplified graphic representations of the conversations, in some embodiments. More details of specific embodiments and of various implementation details will be provided in the following paragraphs.

Gathering Words into Phrases. In at least one aspect of the present invention, a computer-performed process has the ability to gather words together from a transcript by a given speaker into phrases, where the transcription minimally contains the transcribed words, the timing for each word, and speaker attribution for each word, such as the process output of TABLE 1 or its equivalent.

In at least one embodiment of the present invention, the computer-performed process uses alternation between speakers as an extra signal for potential turn boundaries. In one such embodiment the computer-performed process first orders words by start time, regardless of which speaker they are from. The computer-performed process then joins together sequences of words in this ordered set where the speaker remains the same. With reference to the example transcript provided earlier in TABLE 1, the rows (or records) of this table (or database) is sorted by the computer-performed process according to the contents of the start time column ‘start_ms’. The rows in the table are designated as to which speaker, ‘agent’ or ‘client’, contributed each word by the entry in the column ‘speaker’. Contiguous runs of the same speaker are then joined together into phrases which we label P1 through P11, as shown in the column ‘phrase_Ix’.

The result is shown 600 in the swim-lane style visualization of FIG. 6. Phrases P1 through P11 have start times s1 through s11, and end times e1 through e10 (e11 is off the right of the diagram). These start and end times of the phrases are defined as the start time of the first word in the phrase and the end time of the last word in the phrase, respectively. These start and end points are overlaid on FIG. 6 to show the outcome visually.

Note how this process forces alternation between speakers, for example phrase P1 was uttered by the client, phrase P2 was uttered by the agent, phrase P3 by the client etc., Note also that this process does not require any knowledge of the end-times of words. It therefore works with speech-to-text process output formats that only annotate words with start-times. If the output of the speech-to-text process is already ordered according to time stamps, then the new process does not even require start-times. Further, even though the present examples are given relative to two conversing parties, the new process also works with more than two speakers.

This conversant alternation is not a necessary feature for effective visualization. but it is a prerequisite for further embodiments of the invention as described herein. An extension of the at least one embodiment may be to further join together contiguous phrases for the visualization as described above. Considering FIG. 6, the joining of Phrases P5, P7 and P9, for example, makes the sequence more readable. Similarly, phrases P6 and P8 can be visually joined together. Such joining breaks the alternation of turns.

Some speech-to-text services may join words to phrases prior to outputting a result. In such cases the approach above is still relevant and can be used to join shorter phrases together into longer phrases where relevant.

Chat-Style Vertical Visualization Generator Process, The use of horizontal swim-lanes to present computer-based visualizations of spoken conversation are known to those skilled in the art. They are used in existing tools such as contact center conversational analytics platforms. In order to view a conversation, which may be very long, the user must scroll from left to right. The foregoing examples and figures merely showed simple scenarios of just two speakers and about 11 phrases. In practice, actual conversations may have many more parties and many, many more phrases. At least one objective of the present invention is to present the same transcribed conversations into a chat-style visualization, which not only is more intuitive to modern users of text-based messaging services, but also provides for infinite vertical scrolling which represents longer conversations in an easier to understand format.

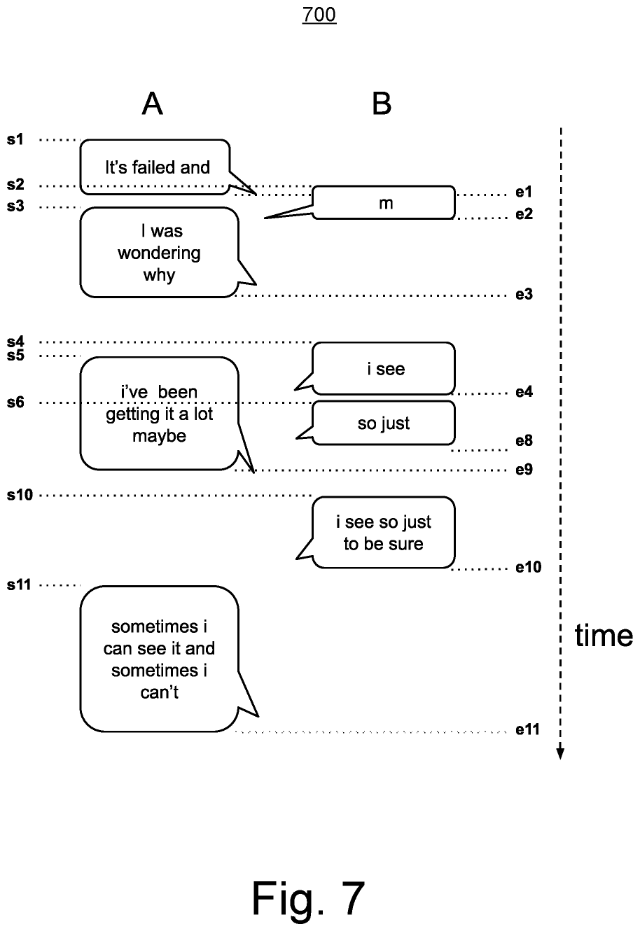

According to at least one embodiment of the present invention, after the words have been automatically joined into phrases, a chat-style vertical visualization of the conversation is automatically generated, and optionally, presented to the user on a computer display, printed report, or other human-machine interface output device. FIG. 7 shows 700 the same dialog as FIG. 6, but visualized in such a “chat” or text-messaging style vertical manner.

As described above the phrases P5, P7 and P9 are joined for visual presentation, as are the phrases P6 and P6. This closely mimics the style of user interfaces used to view text conversations such as SMS messages on mobile devices or contact center chat communications between customers and agents in web-browsers. In order to view these conversations the user scrolls vertically on the computer display. Vertical scrolling is much more common than horizontal scrolling in computer applications on current operating systems such as Windows from Microsoft, Android from Google, or IOS from Apple.

FIG. 7 demonstrates a novel feature, according to at least one embodiment of the present invention, that is not currently used in computer-generated visualizations of text-conversations. The vertical swim-lanes may overlap on the vertical axis. In addition to this novel overlap feature, the vertical axis represents time, and the text boxes are scaled vertically according to the duration of the phrases. The top and bottom of each box line up with the position of the start times (s1 through s8) and end times (e1 through e8) of each of the phrases. The text however continues to be presented horizontally to facilitate easy reading by the user. In this manner, it is evident to the user when two or more speakers were speaking simultaneously into the conversation, as those periods of overlap appear as side-by-side dialog boxes which share some portion of the vertical axis.

By combining the features of joining words into phrases, time scaling the start and end of the text boxes, the use of overlapped lanes for the user, this invention demonstrates how the visualization of spoken dialog can be adjusted to help the user mentally edit the dialog to understand its meaning.

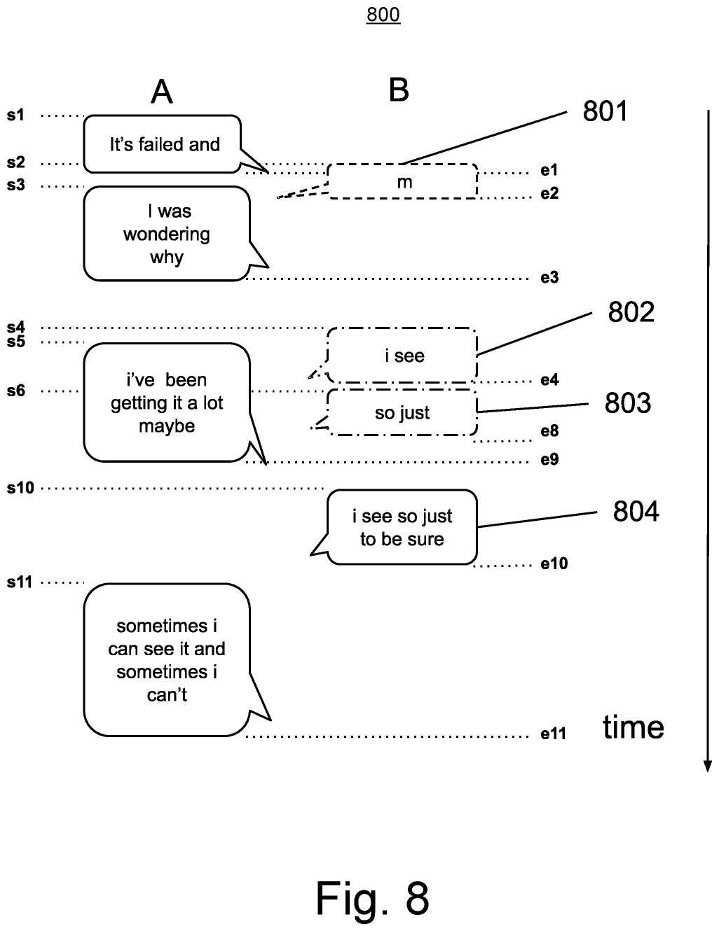

De-emphasis of Back-channels and Back-offs. In at least one embodiment of the present invention, a further novel feature de-emphasizes or elides certain types of time-overlapping speech contributions to present a conversation that is easier to digest visually. FIG. 8 shows 800 the same example conversation as FIG. 7 but with certain features de-emphasized, such as graying-out. Firstly, the back-channel utterance (s2-e2) 801 is de-emphasized, shown in this diagram using a dashed outline for the purposes of monochromatic patent drawings, but in actual embodiments, may be achieved using graying-out, shading or color changes. Back-channels only carry a modest amount of information about the conversation particularly where the speaker is just indicating continued attention, and as such, de-emphasizing this contribution to the conversation allows the user to more readily focus on the more substantial utterances in the conversation. The back-off's at (s4-e4) 802 and (s6-e8) 803 are likewise de-emphasized. This is done automatically because the speaker re-presents this interrupted utterance again (s7-e7) 804 and this re-presentation contains the same content as the backed-off content, completed and located in the correct place in the dialog.

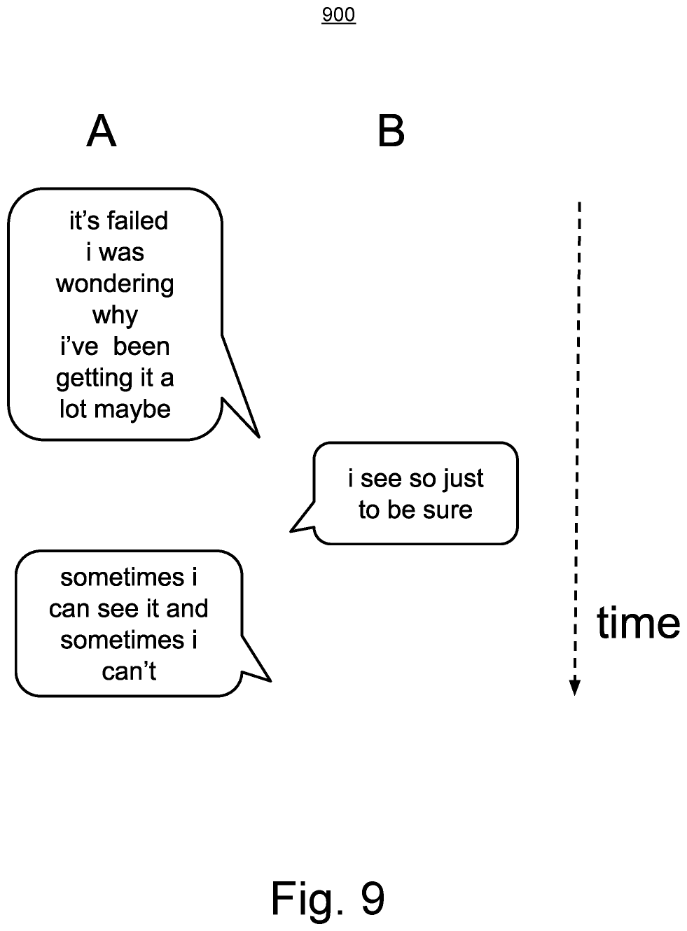

According to another feature available to some embodiments, the back-channel and the backed-off utterances in a conversation are completely elided from the conversation as shown 900 in FIG. 9 without any loss of meaning. Removal of these utterances allows further joining of phrases to form longer phrases. It also restores the alternation which removes the need to communicate the presence of overlapping speech. In some embodiments, a small icon may be displayed approximately where the elided content was originally, allowing the user to restore the missing or hidden conversation content.

In this enhanced embodiment, the removal of overlapping speech removes the need for an accurate time-scale for the vertical axis or indeed the need to represent the presence of overlapping speech in the visualization. The automated process used to detect the presence of back-channels and back-offs is described in in the following paragraphs regarding classifying interjections.

In this embodiment the associated visualization can now be interleaved in the same manner as a text conversation. The user can then interpret this conversation in much the same way as a text conversation and no longer needs to learn any new skills to perceive the content.

Re-ordering of Overlapping Speech. The alternation process described above is helpful for the detection of turn-boundaries at transition relevant points but there are situations where customers both speak over one another in a sustained manner. TABLE 2 shows an example of the output of the speech-to-text engine for a fragment of dialog where this occurs.

TABLE 2
Example Speech-to-Text Process Output with Sustained Overtalk

| start_ms | end_ms | speaker | text |
|---|---|---|---|
| 363078 | 363578 | agent | yes |
| 363603 | 364103 | client | and |
| 364156 | 364656 | agent | and |
| 364402 | 364522 | client | and |
| 364562 | 364842 | client | i |
| 364756 | 364876 | agent | may |
| 364842 | 365121 | client | lost |
| 364956 | 365115 | agent | i |
| 365115 | 365355 | agent | ask |
| 365121 | 365241 | client | a |
| 365241 | 365561 | client | couple |
| 365355 | 365715 | agent | something |
| 365561 | 365761 | client | of |
| 365715 | 366215 | agent | that |
| 365761 | 366261 | client | friends |

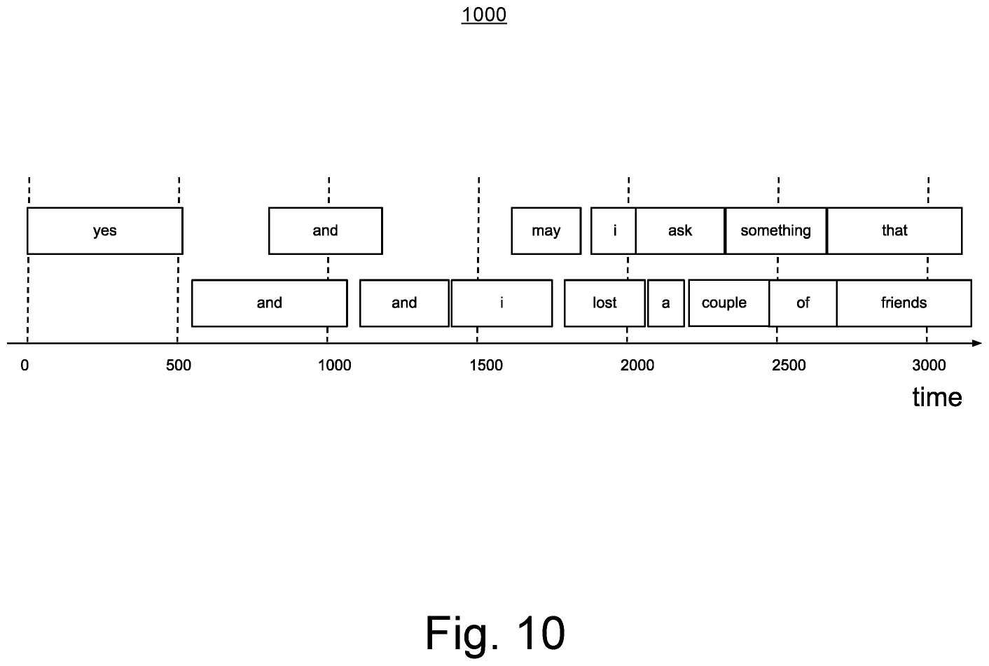

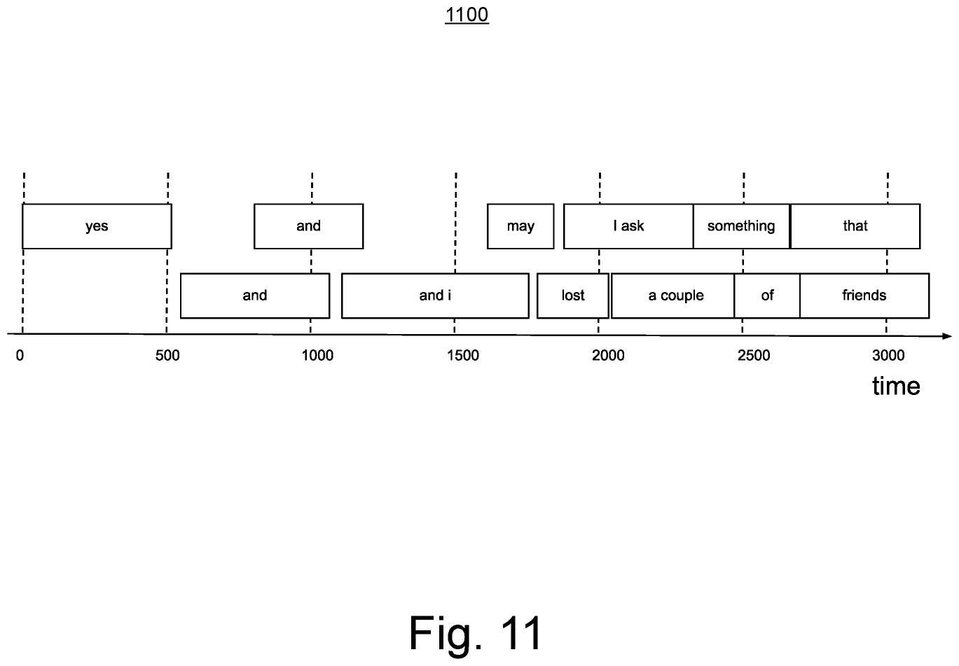

FIG. 10 shows 1000 a horizontal swimlane visualization of the word sequences of TABLE 2 with start and end times aligned. The time axis in FIG. 10 is denoted in milliseconds and is relative to the start time of the first word ‘yes’. FIG. 11 shows 1100 what happens when the turn-gathering process described in this disclosure is applied to example data of TABLE 2. Turn alternation has now been enforced, in this example result, but only a few words have been joined into phrases.

In still other embodiments, the process may further reorder and gather the utterances. The process takes as its input a digital table of utterances or phrases from one conversation, such as the example shown in TABLE 1. Following the same process used to create the data visualized in FIG. 11, this table is ordered in ascending order of start time for each utterance without reference to the speaker. Then, adjacent steps from the same speaker are merged to create an alternation of speakers. Other preprocessing methods can be used. The only prerequisite for the process is that the utterances alternate between speakers.

With this set of alternating utterances, the process selects a start-turn and considers this turn and the three subsequent alternating turns. It decides whether to apply a transformation to this set of utterances or not. For example it might join utterances in the set. It then returns the location of the next unaltered turn as a start point and the automated process repeats the comparison. In this way it works through the whole dialog until there are no utterances left.

This process is repeated for a few iterations starting on a different turn each time to ensure that odd and even turns are treated equally and no possible merges are overlooked. This iteration process is described in the following example pseudo-code:

```
start_turns=[0,1,2,1]
For turn in start_turns:
  while turn < len(utt_table)−4
    turn,utt_table=concat_utterances(turn,utt_table)
  iteration = iteration + 1
```

In this pseudocode example, the function concat_utterances considers the four turns in utt_table starting at turn. The process then optionally transforms these utterances and returns a turn index which is moved forwards in the dialog.

The outer loop of this example pseudocode continues to call concat_utterances until there are less than four turns left in the dialog being processed. Then, the next iteration starts at the start of the dialog again with the start-turn for this iteration. In one particular embodiment, four passes are performed starting at turn 0, 1, 2, and 1 again. Other embodiments may be configured to perform more or fewer passes. Other start turns and numbers of iterations are possible and the automated process is relatively insensitive to the choice of the start-turns. Multiple iterations are important to make sure that all possible opportunities to gather turns together are discovered.

From the example in TABLE 2, each of the four utterances that are input to concat_utterances for comparison have the following three values:
(a) Text—The text of the utterance (a1_text, a2_text, b1_text, and b2_text);
(b) Start Time—The time the utterance starts (a1_start, a2_start, b1_start, and b2_start);
(c) End Time—The time the utterance ends (a1_end, a2_end, b1_end, and b2_end).

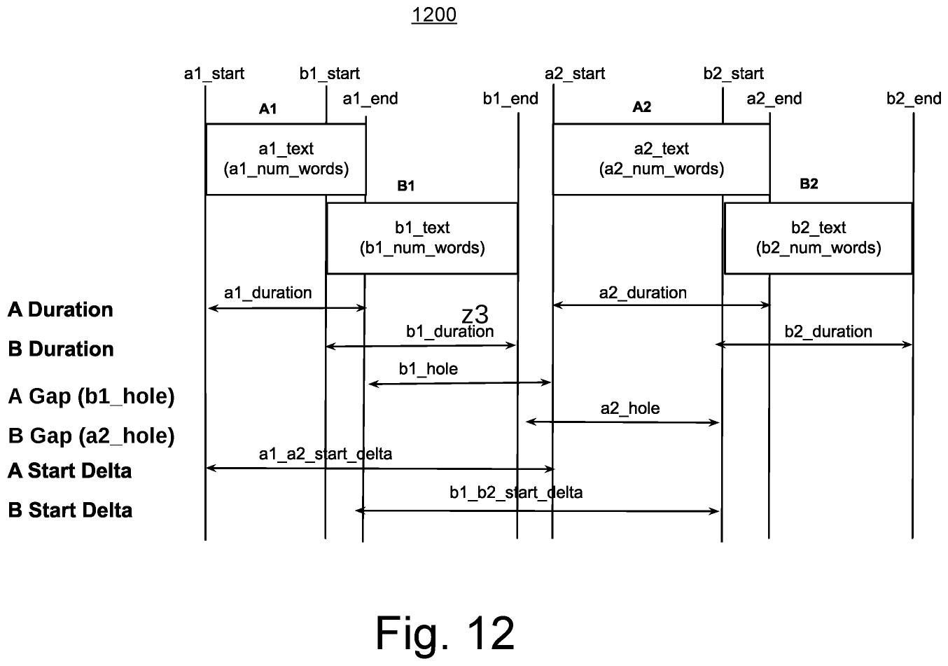

Note that the times in the example data in TABLE 2 are expressed in milliseconds since the start of the interaction but they could be any representation of time. Additional parameters are derived by the process from these measures, such as those shown in FIG. 12, including but not limited to:
(a) Duration—Duration of each utterance (e.g. a1_duration=a1_end−a1_start)
(b) Hole—The gap between the end of the first and start of the second utterance of each speaker (e.g. b1_hole=a2_start−a1_end)
(c) Start Delta—The time between the start of phrases from the same speaker (e.g. a1_a2_start_delta=a2_start−a2_start)
(d) Num_Words—The number of words in an utterance (e.g. a1_num_words=NumWords(a1_text))

The function NumWords counts the number of words delimited by space between words in the text. Other tokenization criteria could be used in other embodiments. An ordered sequence of potential transformation rules are then considered. Each rule has a set of trigger conditions and an associated transform.

TABLE 3 shows a set of rules used in at least one embodiment, which are executed in order from top to bottom in this example.

TABLE 3
Example Set of Rules in Execution Order

| Rulename | Triggers (All must be true) | Transform |
|---|---|---|
| same_span | a1_nwords <= first_words | A1 + A2 |
| | b1_nwords <= first_words | B1 + B2 |
| | a1_a2_start_delta <= same_span | |
| | b1_b2_start_delta <= same_span | |
| other_span | a2_nwords <= second_words | A1 + A2 |
| | a1_a2_start_delta <= other_span | B1 + B2 |
| b1_interject | b1_duration <= floor_grab | A1 + {B1} + |
| | (b1_hole − b1_duration) <= floor_yield | A2 |
| | (b2_start-b1_end) < end_join | B2 |
| a2_interject | a2_duration <= floor_grab | A1 |
| | (a2_hole − a2_duration) <= floor_yield | B1 + {A2} + |
| | (a2_start-a1_end) <= begin_join | B2 |
| end_join | b1_duration <= floor_grab | A1 + A2 |
| | (b1_hole − b1_duration) <= floor_yield | B1 + B2 |
| | (b2_start − b1_end) <= end_join | |
| begin_join | a2_duration <= floor_grab | A1 + A2 |
| | (a2_hole − a2_duration) <= floor_yield | B1 + B2 |
| | (a2_start-a1_end) > begin_join | |

For a transform to be executed, all of its triggers must be true. When a transformation rule is found to be true then the four utterances are transformed into a pair of utterances according to the transform and the turn counter is incremented by four. This means that these four utterances will not be considered again in this pass.

If no rules are triggered, then no transformation is made and the turn counter is incremented by two. This means that the last two utterances of this set of four (A2 and B2) will become the first two utterances (A1 and B1) for the next comparison step in this iteration.

The example rules of TABLE 3 refer to a set of example parameters which are described in TABLE 4 with the example transform patterns described in TABLE 5. The rules show two at least transform patterns—embed and join.

TABLE 4
Example Set of Parameters

| Threshold | | |
|---|---|---|
| Parameter | Default | Description |
| first_words | 10 | A1 and B1 have less than or equal to this |
| | | number of words to be considered for |
| | | same_span concatenation. |
| second_words | 5 | A2 has to be less than or equal to this |
| | | number of words to be considered for |
| | | other_span concatenation. |
| same_span | 10.0 | Maximum seconds between the start of |
| | | A1 and A2 and also between B1 and B2 |
| | | to be considered for same_span |
| | | concatenation. |
| other_span | 0.0 | Maximum seconds between the start of |
| | | A1 and A2 to be considered for |
| | | other_span concatenation. |
| floor_yield | 0.5 | The number of seconds around an |
| | | interjection that indicate the floor was |
| | | yielded. |
| floor_grab | 1.0 | The number of seconds of interruption |
| | | that can be considered a successful floor |
| | | grab. |
| end_join | 2.0 | The maximum time between the end of |
| | | an interjection and the start of the next |
| | | turn that a join can be performed. |
| begin_join | 0.05 | The maximum time between the start of |
| | | an interjection and the end of the |
| | | previous turn that a join can be |
| | | performed. |

TABLE 5
Example Set of Transform Patterns

| Type | Transform | Description |
|---|---|---|
| Join | A1 + A2 | Concatenate A1 and A2 beginning |
| | B1 + B2 | a1_start, ending a2_end. |
| | | Concatenate B1 and B2 beginning |
| | | b1_start, ending b2_end. |
| | | Replace A1, B1, A2, and B2 with |
| | | A1 + A2 followed by B1 + B2. |
| Embed | A1 + {B1} + A2 | Concatenate A1 and A2 beginning |
| | B2 | a1_start, ending a2_end with B2 |
| | | embedded within it as an |
| | | interjection. |
| | | Replace A1, B1, A2, and B2 with |
| | | A1 + {B1} + A2 followed by B2. |
| Embed | A1 | Concatenate B1 and B2 beginning |
| | B1 + {A2} + B2 | b1_start, ending b2_end with A2 |
| | | embedded within it as an |
| | | interjection. |
| | | Replace A1, B1, A2, and B2 with A1 |
| | | followed by B1 + {A2} + B2 |

The embed transform pattern concatenates one pair of utterances from one of the speakers into a longer utterance but also embeds one of the utterances from the other speaker into it as an ‘interjection’. The other utterance is left unchanged. Either B1 is injected into A1+A2 or A2 is injected into B1+B2. In the pattern where B1 is considered to be an interjection into A1 and A2, the utterance B1 can be thought of as either a back-channel or a back-off which overlaps the combined turn of A1 and A2 but does not break its meaning. Thus we treat A1 and A2 as a single utterance and note the interjection of B1 but treat A1 and A2 as a single combined utterance. FIG. 4 shows how such embedded utterances can be de-emphasized in a visualization and FIG. 5 shows how they can be completely elided. In an alternative approach the embedded utterance could itself be deleted from the text altogether.

The join transform pattern concatenates the two pairs of utterances from each speaker into two longer utterances, one from each speaker. This can be thought of as joining A2 to the end of A1 and joining B1 to the start of B2. Words or phrases that were broken into two utterances are now joined as a single utterance. The new bigger utterances keep the start and end times of the two utterances that were joined. The timing of the gap between the two utterances that were joined is lost. The two new bigger utterances from the two speakers can still overlap in time and alternation is preserved.

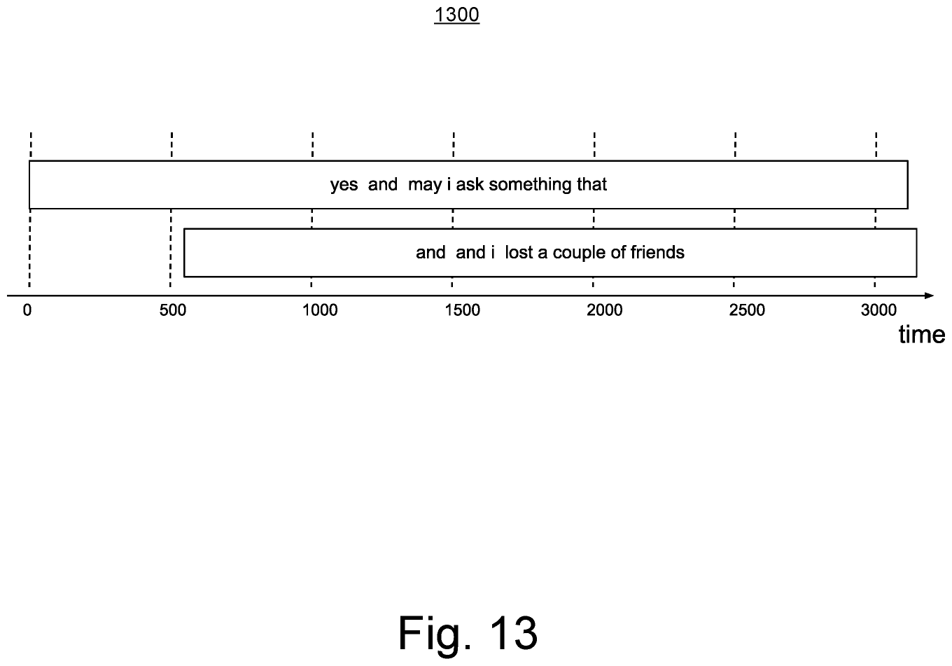

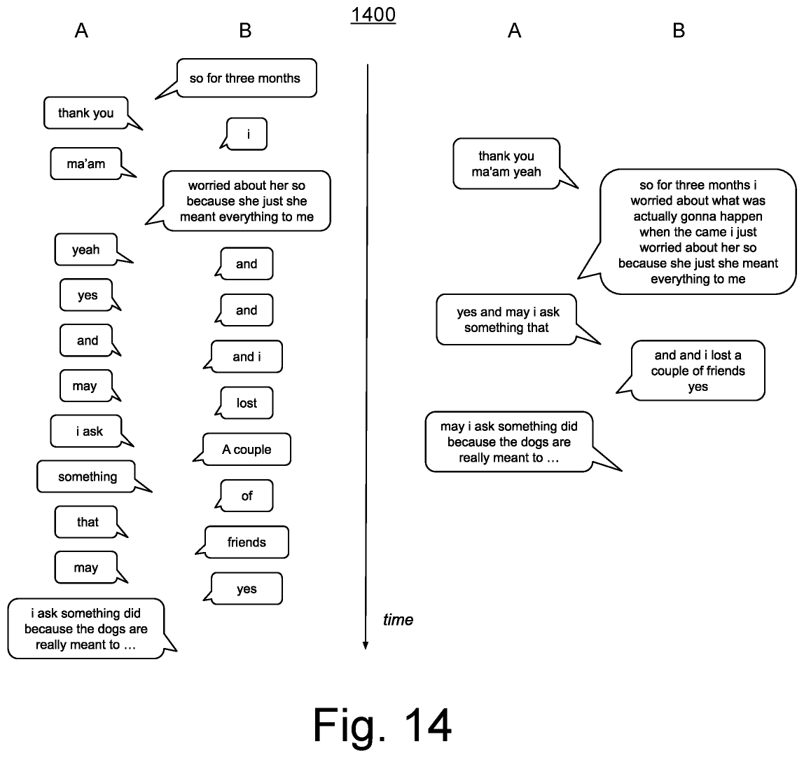

TABLE 6 and FIG. 13 show an example set of results of applying this example process to the utterances shown in TABLE 2 and FIG. 11. It can be seen that sequences of words and phrases have been joined into just two phrases. The time axis in FIG. 13 is in denoted in milliseconds and is relative to the start time of the first word ‘yes’.

TABLE 6
Example Results

| start_ms | end_ms | speaker | text |
|---|---|---|---|
| 363078 | 366215 | agent | yes and may i ask |
| | | | something that |
| 363603 | 366261 | client | and i lost a couple of |
| | | | friends |

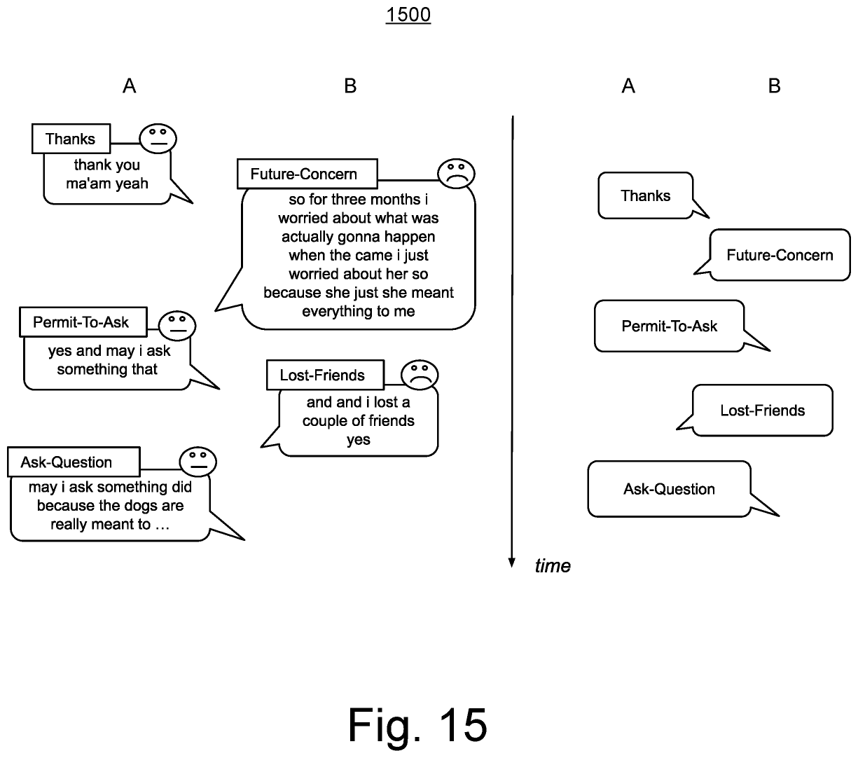

FIG. 14 shows 1400 this fragment of dialog in a wider context. The generated display or graphic on the left of the figure shows a vertical alternating swimlane visualization of a sample dialog that has been transformed by ordering utterances and joining co-located utterances from the same speaker. The generated display or graphic on the right of the figure shows that same fragment of dialog when it has been further processed by the multi-pass process described above. The multi-pass processed dialog visualization (right side) differs from single-pass processed dialog visualization (left side) in two considerable ways:
(a) It contains fewer conversational bubbles, thus reducing the number of separate phrases the user has to read;
(b) It gathers together phrases by each speaker that are distinct in FIG. 10a, thereby creating more coherent units.

It can be seen that the resulting visualized and displayed dialog is easier for a user to read and understand quickly because much of the complexity found in the original transcribed text data is removed and converted into graphic relationships, however, the visualization still retains the structure of the dialog and the intent of the speakers.

Missing End-Times. As has be noted in previous paragraphs, some speech-to-text processes only return (output) the start-time of an utterance and not the end-time. In the absence of end times being provided in the transcription data received by an embodiment of the present invention, the new process uses the start time of the next utterance in the input data table as an approximation for the end-time of the current utterance., e.g. a1_end=b2_start and b1_end=a2_start. This approximation assumes that the utterances are truly alternating with no overlap and no pause between them. The duration parameters become the delta (difference) between the start times of the alternating utterances and the hole parameters are the same as the duration parameters.

TABLE 7 shows how the rules in TABLE 4 are modified when the end times are subject to this approximation. In this example, the rules same_span and other_span are not modified because they do not depend on the end times. The rules b1_interject, a2_interject, end_join, begin_join do use the start and end times and are automatically disabled if the value for floor_yield is non-zero. This is a very useful embodiment according to the present invention under these circumstances. The process no longer attempts to detect interjections or beginning or ending overlaps in such a situation and embodiment.

TABLE 7
Example Rule Modifications when End_Times Are Approximated
by Start_Times of the Subsequent Utterance

| Rulename | Triggers (All must be true) | Transform |
|---|---|---|
| same_span | a1_nwords <= first_words | A1 + A2 |
| | b1_nwords <= first_words | B1 + B2 |
| | a1_a2_start_delta <= same_span | |
| | b1_b2_start_delta <= same_span | |
| other_span | a2_nwords <= second_words | A1 + A2 |
| | a1_a2_start_delta <= other_span | B1 + B2 |
| b1_interject | (a2_start-b1_start) <= floor_grab | A1 + {B1} + A2 |
| | (0) <= floor_yield | B2 |
| | (b2_start-a1_start) < end_join | |
| a2_interject | (b2_start-a2_start) <= floor_grab | A1 |
| | (0) <= floor_yield | B1 + {A2} + B2 |
| | (a2_start-b1_start) <= begin_join | |
| end_join | (a2_start-b1_start) <= floor_grab | A1 + A2 |
| | (0) <= floor_yield | B1 + B2 |
| | (b2_start-a1_start) <= end_join | |
| begin_join | a2_duration <= floor_grab | A1 + A2 |
| | (0) <= floor_yield | B1 + B2 |
| | (a2_start-b1_start) > begin_join | |

Classifying interjections. The transformation rules b1_interject and a2_interject detect short utterances from one speaker that overlap the other speaker with little or no additional pausing from the other speaker at the point of the overlap. This simple rule is quite effective at identifying back-channels, back-offs and short recognitional overlaps. In some cases it may be helpful to further classify these interjections.

For a given language, the common lexical forms of back-channels can be enumerated. In US English for example these would include, but are not constrained to, continuers such as ‘uh huh’, ‘hmm’, ‘yeah’, ‘yes’, and ‘ok’. The phrases ‘thank you’, ‘thanks’, and ‘alright’ perform the dialog function of grounding or acknowledgment; These phrases function in a similar manner to back-channels in contexts that the automated process detects as an interjection. The phrase ‘oh’ indicates surprise but again functions like a back-channel when classified as an interjection.

According to other embodiments, a white list of words and phrases that are known to function as back-channels when detected as an interjection may be added to the process. For US English, this list might include the word and phrases mentioned above and could be extended or edited by someone skilled in the art. Other languages will have other equivalent sets of words or phrases or paralinguistic features which can be included if the speech-to-text engine supports them. If this list of words or phrases matches the phrase b1_text when the b1_interject rule is triggered or matches a2_text for the a2_interject rule then these interjections are considered to be back-channel interjections, as discussed elsewhere in this disclosure.

Examples of back-channel interjections detected by the automated process are shown in TABLE 8. In the table the interjection from one speaker is shown in curly braces embedded within the combined turn from the other speaker.

TABLE 8
Examples of Detected Back-Channel interjections
Speaker A or B

i don't have much data i don't pay for very much data but i {m}
have never gone over i used wifi when i'm at home {m} or were
let me check ok the eleven o four that is the right passcode in the
account so sarah {ok} i've already authenticated your account give
me a couple of moments here to pull up your account ok
see it should started over yesterday though it's {yeah} the twenty
fourth through the twentieth i don't know but so {oh} it's so i've
used a lot of data since it started over right
and that's not {alright} very much so how did i use so much
years ago and all of a sudden i'm calling about that in the internet i
used it up {alright} that's crazy i think at just i don't know
because apparently what my phone is showing is over over usage
{yes} right i mean {yeah} it's over what i have actually used
because it's saying six point seven
no i'm not now i do walk like i told you i walk with these dogs daily
and i do have my data on them and {yeah} i do check messages
and that's what i've been doing but {yeah} no i did not turn it off i
am guilty i thought i usually turn it off i don't know {yeah} why i did i
guess maybe it just didn't yesterday
alright ok and that {thank you} is know easy if you do have by
anything else i'll be happy to hear from you more and please care
of yourself

Any remaining interjections can be further classified by the process as restarted or continued back-offs. In some embodiments, restarted back-offs can be detected by the process by matching the text of the interjected utterance with the beginning of the next turn. In at least one embodiment, an interjection is classified by the process as a restarted back-off if there is an exact match between the interjection text and the left hand start of the following text from the same speaker with and without the first word removed.

TABLE 9 shows examples of interjections that are classified by the process as restarted back-offs. Interjections that are not classified as back-channels or restarted back-offs are classified as continued back-offs.

TABLE 9
Examples of Interjections Classified as Restarted Back-offs.

| Speaker A | Speaker B |
|---|---|
| yes sir you need to enter it like | on ok hold on it says password not |
| you know i'm {ok hold} seeing | found |
| that | |
| it doesn't let do anything in my | so the mobile data is not turned on |
| web browser the require and then | correct |
| the internet {so} collection | |
| and it tells tells me i've used | yep that's right yes that's correct i |
| ninety five that this isn't absolutely | m |
| correct but it's a good {that's | |
| right} reference point | |

TABLE 10 shows examples of interjections that are classified by the process as continued back-offs. Sub-classification of these three different types of interjection enables different transforms to be performed by the process on the data and/or different visualization of the text to be automatically generated. For example, back-channels and restarted back-offs could be completely removed from the dialog text or hidden or de-emphasized in the visualization whereas continued back-offs could be moved to the start of the next turn following the same transformation pattern as an end_join.

TABLE 10
Examples of Interjections Classified as Continued Back-offs.

| Speaker A | Speaker B |
|---|---|
| your sim card i {first i} see | did one on one on my own |
| it's {so} not what | let me double ii mean it's not you |
| | because this entire number |
| | should be updated here in our you |
| | know in our system |
| susan alright do you {these are} | things i don't know |
| for me to be able | |
| have you made a lot of calls or | my plan isn't correct that i have |
| used your at it actually {ok so} | that they've given me they've told |
| depends it actually depends on the | me data starts over on the twenty |
| activity that your ok | fourth but you're saying the |
| | fifteenth |

Representing Phrases Using Non-Tabular Representations in General. The process described uses a method of operating on a tabular representation of phrases and re-structures this representation to implement the transformation. Other embodiments of the process may implement methods to gather words into phrases and, optionally, to gather phrases into larger phrases. Still other embodiments may incorporate or use other representation methods suggested by extrinsic sources available to those ordinarily skilled in the art. Such embodiments may utilize different structural representations of in addition to or alternative to organizing the dialog information in a linear table, while applying the same principles, methods and transforms according to the present invention to those different representations to achieve the objectives and benefits of the present invention.

For example, stand-off annotation such as the NXT XML format as disclosed by Calhoon (2010) may be integrated into the a process according to the present invention. Such formats, for example, separate the text of a transcription from annotated features of the conversation. The trigger rules and transform functions described by the process may be adapted to work with such a method. For example start and end pointers may be used by the process to represent the gathered phrases described in the method and these pointers may be transformed by the rules. Such a stand-off annotation format is well suited to further annotate the classification of interruption and overlap types.

Applying Text Processing Methods to Spoken Dialog. In addition to providing benefits for the visualization of spoken conversations, one or more of the embodiments according to the present invention may also be used to improve the performance of computer systems that analyze conversations and extract information from them. Examples of such systems would include conversational analytics platforms such as, but not limited to, Talk Discovery™ supplied by Discourse.AI Inc., also known as Talkmap, of Dallas, Texas.

Such state-of-the-art conversational analytics computing platforms often receive as input digital information including text of turns in a conversation labeled with the different speaker identities for each turn (utterance, phrase, etc.) in the conversation. Various processes are employed by these conversational analytics computing platforms to extract meaning or to classify emotion or intent from these conversations. Many such conversational analytics computing platforms have been trained or designed to work on written text such as transcripts of chat conversations on a web-site. In order to utilize the processes of the present invention on transcripts of spoken conversations, it is helpful, and often essential, to transform the spoken dialog into a form that closely resembles text-based conversations.

The embodiments of the present invention can, therefore, be used to enable advanced conversation analysis systems designed for or trained with text conversational data to be used effectively with spoken conversations without the need to train new models or design new processes.

Visualizations of Meaning and Emotion. FIG. 15 shows 1500 an example of a visualization of a conversation generated by at least one embodiment of the present invention where the utterances have been classified with labels of meaning, emotion, or both meaning and emotion. In the example on the left side of FIG. 15, the dialog of FIG. 14 has been augmented and improved by the automatic addition of meaning labels such as Thanks' or ‘Future-Concern’. Those skilled in the art will recognize how such labels of meaning, sometimes termed ‘intents’, can be derived for each utterance using other methods available in the art. In a further embodiment, labels of affect or emotions can also be added for each utterance, also shown in the left portion of FIG. 15 by the neutral and sad face icons. The right portion of FIG. 15 shows a further embodiment which shows how, once such labels have been derived, the conversation can be visualized using one or more of the labels to replace the original text of the conversation to provide a different level of visual abstraction for a conversation.

### Other Embodiments

In at least one embodiment, the foregoing processes are implemented as an extensible framework into which additional sub-processes and transforms may be easily integrated and incorporated. Other methods for identifying turn boundaries and classifying the function of utterances in spoken conversations may be integrated into the solution process described in the foregoing paragraphs, such as but not limited to other processes available from the extrinsic art that make decisions based on text, timing and speaker identities alone.

In other embodiments according to the present invention, when the source audio digital recording is available to the process, additional signals such as the intensity and pitch of voice or the shortening or lengthening of words can be used by the process to the techniques described here to identify potential transition relevant places or classify competitive or cooperative interruptions.

As such, embodiments of the present invention are not limited by the method(s) used to discover the boundaries of utterances or categorize their function or group phrases together, nor are the limited by the transforms which are applied to the text.

### CONCLUSION

The “hardware” portion of a computing platform typically includes one or more processors accompanied by, sometimes, specialized co-processors or accelerators, such as graphics accelerators, and by suitable computer readable memory devices (RAM, ROM, disk drives, removable memory cards, etc.). Depending on the computing platform, one or more network interfaces may be provided, as well as specialty interfaces for specific applications. If the computing platform is intended to interact with human users, it is provided with one or more user interface devices, such as display(s), keyboards, pointing devices, speakers, etc. And, each computing platform requires one or more power supplies (battery, AC mains, solar, etc.).

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Certain embodiments utilizing a microprocessor executing a logical process may also be realized through customized electronic circuitry performing the same logical process(es). The foregoing example embodiments do not define the extent or scope of the present invention, but instead are provided as illustrations of how to make and use at least one embodiment of the invention.

I/We claim:

1. A method of preparing a visual depiction of a conversation, comprising steps of:
accessing, by a computer processor, a digital text-based transcript of an unstructured multi-party audio conversation;
extracting, by a computer processor, from the digital transcript a plurality of utterances, wherein each utterance is associated with at least one digital time code;
applying, by a computer processor, one or more rules and one or more transformations to resolve one or more time-sequence discrepancies between dialog features;
preparing, by a computer processor, a digital visualization in a format which resembles a message-based conversation containing the plurality of utterances organized in a time-sequential format wherein the visualization includes the resolutions to the time-sequence discrepancies; and
outputting, by a computer processor, the visualization to one or more computer output devices selected from the group consisting of a computer display, a digital file, a return parameter to another computer process, a communication port, and a printer.

2. The method of claim 1 wherein the conversational format of the output visualization resembles a short message service (SMS) text messaging user interface.

3. The method of claim 2 wherein the short message service (SMS) text messaging user interface visualization format comprises conversation bubble graphical icons containing text representing conversation turns.

4. The method of claim 1 wherein the digital text-based transcript comprises an output received from or created by a speech-to-text conversion process.

5. The method of claim 1 wherein the digital time codes associated with the extracted utterances comprise a start time of each utterance.

6. The method of claim 1 wherein the digital time codes associated with the extracted utterances comprise an end time of each utterance.

7. The method of claim 1 wherein the applying of one or more rules and one or more transformations is repeated at least once to provide at least two passes of rule and transformation application.

8. The method of claim 1 wherein the one or more rules comprise one or more rules selected from the group consisting of a same_span rule, an other_span rule, a party_interjection rule, and end_join rule, and a begin_join rule.

9. The method as set forth in claim 8 further comprising classifying an interjection according to at least one party_interjection rule comprises classifying interjections according to one or more interjection types selected from the group consisting of a back-off interjection, a restarted back-off interjection, and a continued back-off interjection.

10. The method of claim 1 wherein the one or more transformations comprise one or more transformations selected from the group consisting of a join transformation and an embed transformation.

11. The method as set forth in claim 1 wherein the resolving of one or more time-sequence discrepancies between dialog features further comprises de-emphasizing in the prepared visualization one or more non-salient dialog features.

12. The method as set forth in claim 11 wherein the de-emphasizing comprises eliding one or more non-salient dialog features.

13. The method as set forth in claim 11 wherein the non-salient dialog features comprise one or more dialog features selected from the group consisting of a backchannel utterance and a restart utterance.

14. The method as set forth in claim 1 wherein the prepared and outputted visualization comprises vertical swimlanes of conversation bubbles, wherein each swim lane represents utterances and turns in the conversation by a specific contributor.

15. The method as set forth in claim 14 wherein the preparing of the visualization comprises applying at least one rule or one transformation to combine one or more utterances into one or more phrases.

16. The method as set forth in claim 15 further comprising applying at least one rule or one transformation to combine one or more phrases into one or more larger phrases.

17. The method as set forth in claim 14 wherein the applying of at least one rule or one transformation comprises generating a visual depiction of time overlaps between two conversation bubbles.

18. The method as set forth in claim 14 wherein the applying of at least one rule or one transformation comprises preventing visual depiction of time overlaps between two conversation bubbles.

19. The method as set forth in claim 1 wherein the preparing, by a computer processor, the digital visualization further comprises augmenting or replacing at least one resemblance of a message with at least one label representing a meaning of the utterance, or an emotion of the utterance, or both a meaning and an emotion of the utterance.

20. A computer program product for preparing a visual depiction of a conversation, comprising:
a non-transitory computer storage medium which is not a propagating signal per se; and
one or more computer-executable instructions encoded by the computer storage medium configured to, when executed by one or more computer processors, perform steps comprising:
accessing a digital text-based transcript of an unstructured multi-party audio conversation;
extracting from the digital transcript a plurality of utterances, wherein each utterance is associated with at least one digital time code;
applying one or more rules and one or more transformations to resolve one or more time-sequence discrepancies between dialog features;
preparing a digital visualization in a format which resembles a message-based conversation containing the plurality of utterances organized in a time-sequential format wherein the visualization includes the resolutions to the time-sequence discrepancies; and
outputting the visualization to one or more computer output devices selected from the group consisting of a computer display, a digital file, a return parameter to another computer process, a communication port, and a printer.

21. A system for preparing a visual depiction of a conversation, comprising:
one or more computer processors;
a non-transitory computer storage medium which is not a propagating signal per se; and
one or more computer-executable instructions encoded by the computer storage medium configured to, when executed by the one or more computer processors, perform steps comprising:
accessing a digital text-based transcript of an unstructured multi-party audio conversation;
extracting from the digital transcript a plurality of utterances, wherein each utterance is associated with at least one digital time code;
applying one or more rules and one or more transformations to resolve one or more time-sequence discrepancies between dialog features;
preparing a digital visualization in a format which resembles a message-based conversation containing the plurality of utterances organized in a time-sequential format wherein the visualization includes the resolutions to the time-sequence discrepancies; and
outputting the visualization to one or more computer output devices selected from the group consisting of a computer display, a digital file, a return parameter to another computer process, a communication port, and a printer.
